(19) United States
(12) Patent Application Publication
(10) Pub. No.: US 2022/0198498 A1
(43) Pub. Date: Jun. 23, 2022

(54) METHOD AND SYSTEM FOR UPLIFT PREDICTION OF ACTIONS

(71) Applicant: Beijing DiDi Infinity Technology and Development Co., Ltd., Beijing (CN)

(72) Inventors: Tao HUANG, SAN JOSE, CA (US); Zhiwei QIN, SAN JOSE, CA (US); Qingyang LI, SUNNYVALE, CA (US); Wenjie SHANG, BEIJING (CN)

(21) Appl. No.: 17/124,763

(22) Filed: Dec. 17, 2020

(51) Int. Cl. G06Q 30/02; G06Q 20/38

(52) U.S. Cl. CPC G06Q 30/0211; G06Q 20/387; G06Q 30/0222; G06Q 30/0239

(57) ABSTRACT

A computer-implemented method for determining incentive distribution includes: obtaining, by a computing device, a computer model, the computer model being configured to: obtain state information of a user of a platform and an incentive action of the platform, and generate simulation results on at least one performance criterion of the platform with and without the incentive action being provided to the user; receiving a computing request comprising state information of one or more visiting users; determining, by feeding the state information and the incentive action to the computer model, an uplift on the at least one performance criterion by providing the incentive action. By evaluating the uplift effect based on statistical distribution of the order and reward, the activeness of the user, and counter-factual balance of the data, the method improves the accuracy of the uplift prediction, thereby improving efficiency and accuracy of the incentive distribution.

### TECHNICAL FIELD

The specification relates generally to determining distribution of resources, and more specifically, to systems of methods for uplift predictions of actions based on distribution of the resources.

### BACKGROUND

Online ride-hailing companies frequently provide various resources, such as incentives, to their drivers and/or passengers to encourage the usage of their service. However, conventional computing technology for evaluating uplift effects of an incentive action provides poor allocation of incentive actions. Therefore, an intelligent and adaptive tool to predict the uplift effects of various incentives is desirable to improve the determination of incentive distribution.

### SUMMARY

One aspect of the present specification is directed to a computer-implemented method. The method may comprise obtaining, by a computing device, a computer model. The computer model may include an input unit, a processing unit, and an output unit.

The input unit may be configured to: obtain state information of a user of an online platform, obtain an incentive action comprising a reward provided by the online platform to the user, encode the state information of the user to generate encoded state information, and encode the incentive action to generate an encoded action vector.

The processing unit may be configured to: determine, based on the encoded state information and the encoded action vector, a first simulation result of at least one performance criterion of the online platform when the incentive action is provided to the user, a second simulation result of the at least one performance criterion of the online platform when no incentive action is provided to the user, and a probability of activeness of the user using the online platform, determine, based on the first simulation result and an order distribution function, a probability of reward representing a probability of the user receiving the reward in the incentive action, and output the first and the second simulation results, the probability of activeness, and the probability of reward.

The output unit may be configured to: determine, based on the first and the second simulation results, the probability of activeness, and the probability of reward, an uplift on the at least one performance criterion of providing the incentive action to the user.

The method may further include: receiving, by the computing device, a computing request related to one or more visiting users visiting the online platform, wherein the computing request comprises state information of the one or more visiting users; determining, by feeding the state information of the one or more visiting users and one or more incentive actions to the computer model, an uplift on the at least one performance criterion of providing each of the one or more incentive actions to a target group comprising at least one of the one or more visiting users; determining, based on an uplift on the at least one performance criterion, one of the one or more incentive actions to be applied to the target group; and transmitting, by the computing device, a return signal to the target group, the return signal comprising the one incentive action.

In some embodiments, determining one of the one or more incentive actions to be applied to the target group may comprise: determining, based on the probability of reward and the order distribution function, a cost associated with the incentive action; and determining, based on the uplift on the at least one performance criterion and the cost associated with the incentive action, the one of the one or more incentive actions to be applied to the target group.

In some embodiments, the online platform may be a ride-hailing platform, the incentive action may be a tiered coupon including a plurality of rewards each corresponding to one of a plurality of threshold order amounts. Determining the cost associated with the incentive action may include: determining, based on the order distribution function, the probability of reward for each of the plurality of rewards in the tiered coupon; and determining, based on the probability of reward for each of the plurality of rewards in the tiered coupon, the cost associated with the incentive action.

In some embodiments, the state information of the user may include one or more time series features of the user and one or more static features of the user. The one or more time series features may include one or more time-variant features of the user, and the one or more static features may include one or more time-invariant features of the user. The time series features may include one or more of: time information, weather information, location information, and traffic condition information. The static features may include one or more of: a name of the user, a gender of the user, and vehicle information.

In some embodiments, the processing unit may include a first component and a second component each comprising one or more neural networks. The first component may be configured to generate the first simulation result based on the encoded state information and the encoded action vector, and the second component may be configured to generate the second simulation result based on the encoded state information.

In some embodiments, the first component may include one or more processing neural networks and one or more final prediction neural networks. The one or more processing neural networks may be configured to generate one or more processed vectors corresponding to the first simulation result based on the encoded state information and the encoded action vector, and the one or more final prediction neural networks may be configured to generate the first simulation result based on the one or more processed vectors.

The second component may include one or more processing neural networks and one or more final prediction neural networks. The one or more processing neural networks may be configured to generate one or more processed vectors corresponding to the second simulation result based on the encoded state information, and the one or more final prediction neural networks may be configured to generate the second simulation result based on the one or more processed vectors.

In some embodiments, the online platform may be a ride-hailing platform, and the user may be a driver of a vehicle or a passenger seeking transportation in a vehicle. The at least one performance criterion may include one or more of the following within a preset period of time: an order amount of the online platform, a number of active users of the online platform, a gross merchandise volume (GMV) of the online platform, and a gross profit of the online platform.

In some embodiments, obtaining the computer model may include: training the computer model. Training the computer mode may include: acquiring a plurality of historical records of the platform, each of the historical records containing state information of each historical user; pre-processing the historical records by adding an activeness feature, a reward label feature, and an event feature to the state information of each historical user, the activeness feature indicating whether the historical user is active, the reward label feature indicating a reward received by the historical user, and the event feature indicating whether the historical user was provided a historical incentive action; generating, based on the historical records, basic simulation results for the at least one performance criterion corresponding to the plurality of historical records; adjusting, based on the basic simulation results and the historical records, a plurality of parameters of the computer model.

In some embodiments, training the computer model may further include: grouping, based on the state information of the plurality of historical records, the historical records into a plurality of counter-factual pairs, each counter-factual pair including a first historical record with an incentive action being provided, and a second historical record with no incentive action being provided; and determining, for each of the historical records in the counter-factual pairs, a counter-factual simulation result. Adjusting the plurality of parameters of the computer model may include: adjusting, based on the basic simulation results, the counter-factual simulation results, and the historical records, the plurality of parameters of the computer model.

Another aspect of the present specification is directed to a computer device, comprising a processor and a non-transitory computer-readable storage medium configured with instructions executable by the processor. Upon being executed by the processor, the instructions may cause the processor to perform operations. The operations may be any one or more of the aforementioned computer-implemented methods.

Another aspect of the present specification is directed to a non-transitory computer-readable storage medium, configured with instructions executable by a processor. Upon being executed by the processor, the instructions may cause the processor to perform operations. The operations may include any one or more of the aforementioned computer-implemented methods.

The computing technology herein disclosed evaluates the uplift effect of an incentive action based on the statistical distribution of the order and reward, the activeness of the user, and counter-factual balance of the data, and improves the accuracy of the uplift prediction, thereby improving efficiency and accuracy of the incentive distribution.

These and other states of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates a flow chart of a computer-implemented method for determining incentive distribution in accordance with various embodiments of the specification.

FIG. 2 illustrates a block diagram illustrating a computer model for a computer-implemented method for determining incentive distribution in accordance with various embodiments of this specification.

FIGS. 3A, 3B, and 3C illustrate diagrams of computer models for determining incentive distribution, in accordance with various embodiments of the specification.

FIG. 4 illustrates a flow chart of a method for training a computer model for determining incentive distribution in accordance with various embodiments of the specification.

FIG. 5 illustrates a flow chart illustrating a method for pre-processing historical records for training the computer model in accordance with various embodiments of the specification.

FIG. 6 illustrates an example showing the pre-process of the historical records for training the computer model in accordance with various embodiments of the specification.

FIG. 7 illustrates a block diagram of a computer system for determining incentive distribution in accordance with various embodiments of the specification.

FIG. 8 illustrates a block diagram of a computer system in which any of the embodiments described herein may be implemented.

### DETAILED DESCRIPTION OF THE EMBODIMENTS

Specific, non-limiting embodiments of the present invention will now be described with reference to the drawings. It should be understood that particular states and aspects of any embodiment disclosed herein may be used and/or combined with particular states and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope, and contemplation of the present invention as further defined in the appended claims.

Online platforms frequently provide various resources, like incentive, to promote their businesses. However, existing computing technology evaluates the uplift effect of these incentive actions based solely on static factors, and hence does not provide an accurate prediction on the uplift effect to the business performance of an online platform. As a result, the selected incentive action does not provide a satisfying return to the platform.

In view of the above limitations, this specification first presents a computer-implemented method for determining resource, e.g., incentive, distribution.

The computer-implemented method may be performed by a computing device. The computing device may include one or more processors and memory (e.g., permanent memory, temporary memory). The processor(s) may be configured to perform various operations by interpreting machine-readable instructions stored in the memory. The computing device may include other computing resources and/or has access (e.g., via one or more connections/networks) to other computing resources. The computing device may be implemented as a single computing entity, or it may be implemented as multiple computing entities each performing to a portion of the functionalities connected with each other through wired or wireless connection. This specification is not limited in this regard.

The computer-implemented method may be applicable to a platform. A platform may refer to an online service platform providing a service conducted by a service-provider to a service-requester. An incentive action may refer to an action, taken by the platform, that motivates or encourages one or more users of the platform to take certain action(s). In this specification, an incentive action to a user is denoted by a, and may include distributing a tangible object and/or an intangible object to a user. For example, an incentive action may include distributing a physical and/or a digital coupon to a user. A user may refer to a person or a group of persons using the service of the platform.

In this specification, for the ease of description, a ride-hailing platform is used as an exemplary platform, and distributing coupon is used as an exemplary incentive action. This specification is not limited in this regard, and other platforms and other forms of incentive actions are contemplated.

Different types of coupons may be distributed to the drivers. For example, the coupon may be a fix-amount coupon for completing an order, e.g., giving a coupon of $3 to the driver or the passenger when an order is completed. The coupon may be a conditional coupon that gives out a reward after a certain number of orders are completed, e.g., a coupon of $3 after the total number of orders reaches 30 (denoted by a=(30,3)). The coupon may be a tiered coupon that gives out different amounts of rewards based on different numbers of orders being reached, e.g., a coupon of $3, $4, $5 when the order amount (i.e., the number of orders) reaches 30, 35, and 40, respectively (denoted by a=[(30,3), (35,4), (40,5)]). Generally, a tiered coupon may be described as: a=[(x₁,y₁), (x₂,y₂), . . . , (xₙ,yₙ)] wherein xᵢ represents threshold order amount for each level of reward, and yᵢ represents the corresponding reward when the order amount reaches the threshold xᵢ. In some embodiments, coupons may also be provided to passengers to motivate the passengers to use the vehicles for rides, and this specification is not limited in this regard.

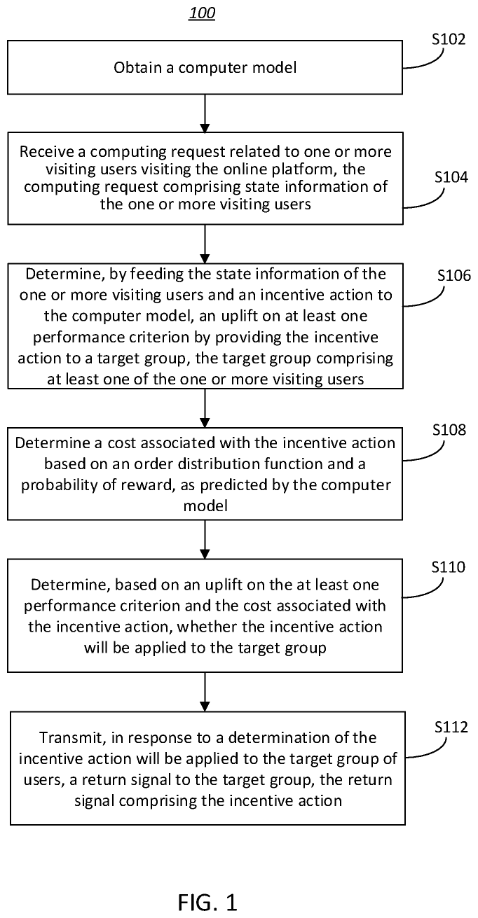

FIG. 1 illustrates a flow chart of a computer-implemented method for determining incentive distribution in accordance with various embodiments. Referring to FIG. 1, the computer-implemented method 100 for determining incentive distribution may include the following steps S102 through S112.

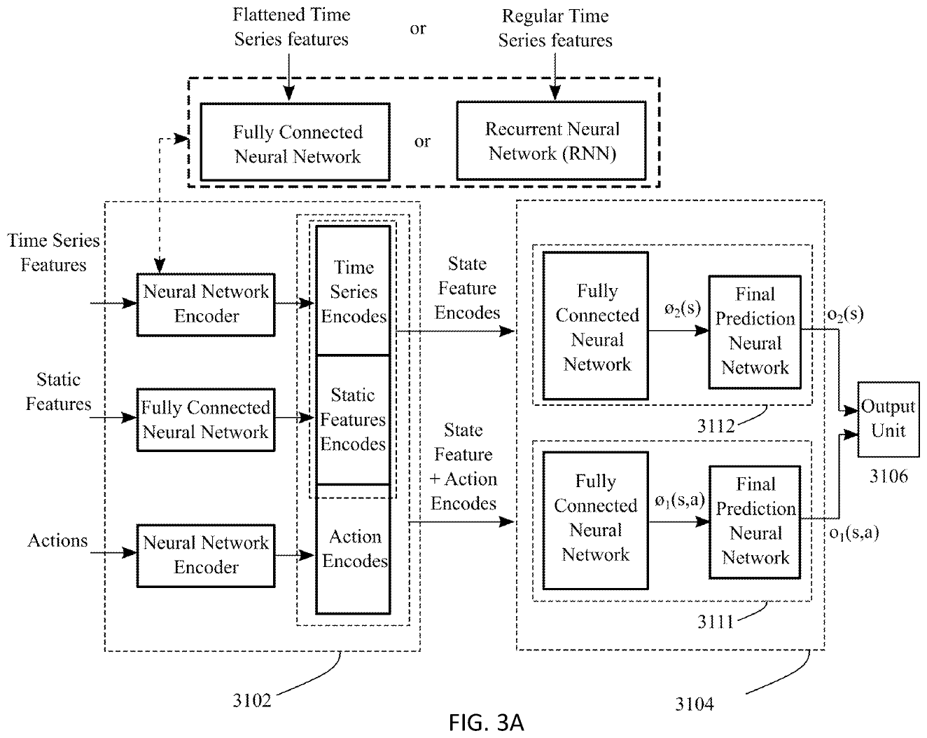

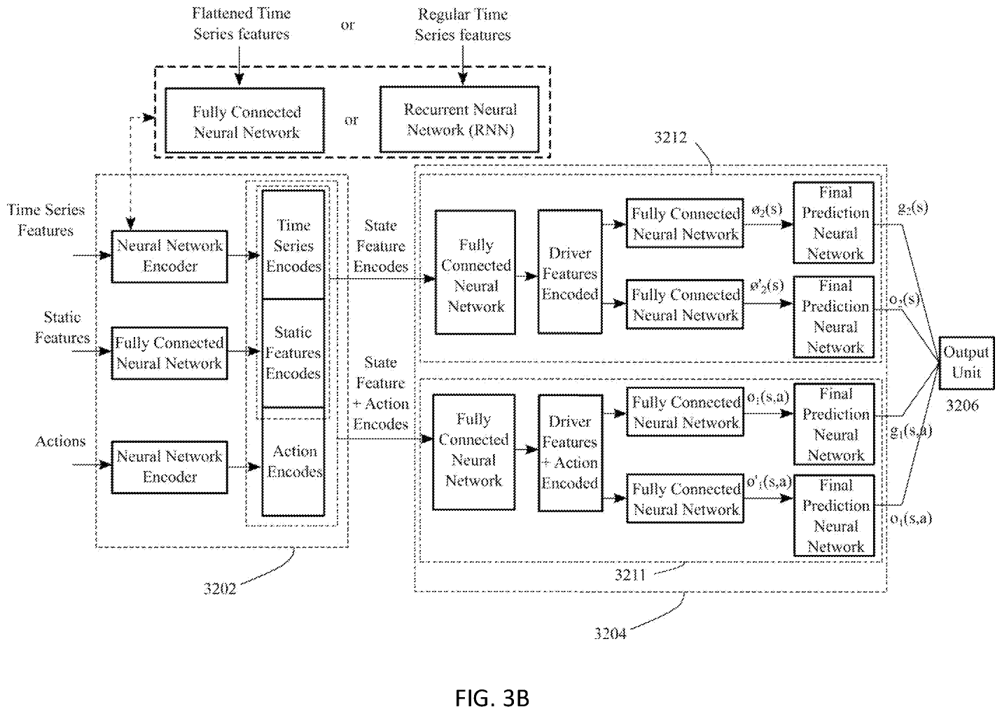

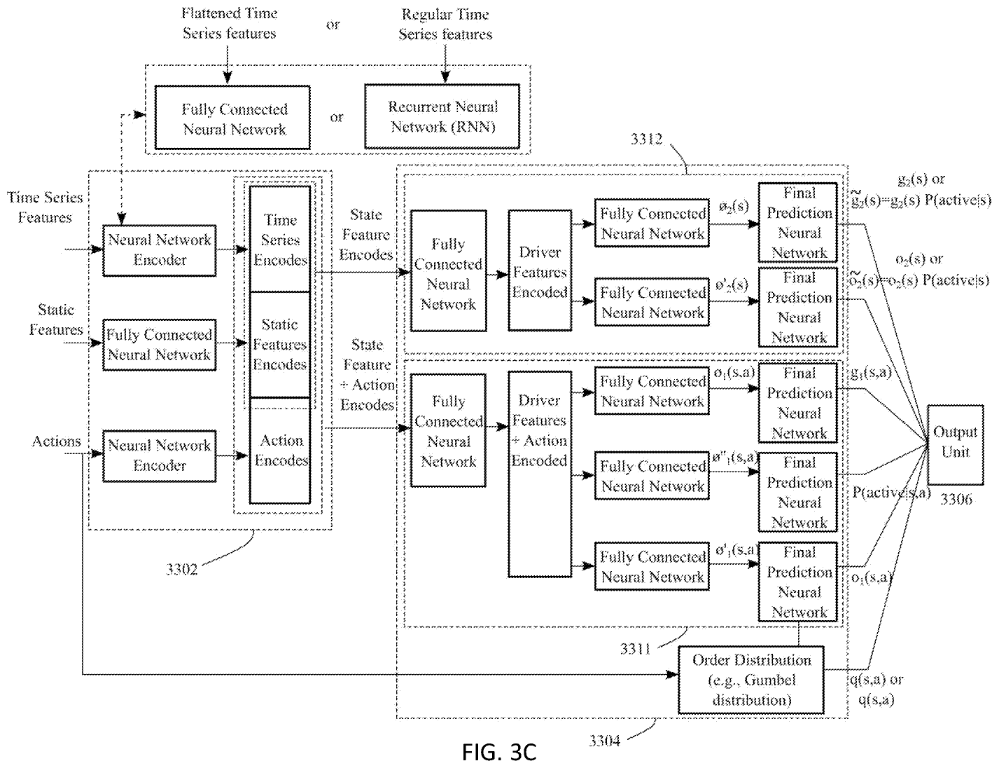

In step S102, the computing device may obtain a computer model. Details of the computer model will be described below with reference to FIGS. 3A, 3B, and 3C.

In step S104, the computing device may receive a computing request related to one or more visiting users visiting the online platform. The computing request may comprise state information of the one or more visiting users. In some embodiments, the computing request may be received and processed in real-time on an as-needed basis. In some embodiments, the computing request may be received and processed in a fixed interval (e.g., one computing request per day). This specification is not limited in this regard.

In some embodiments, state information of individual users of the platform may refer to attributes, characteristics, aspects, and/or other features of the users, and may include static features and/or time series features. For example, the state information of passengers/drivers may include one or more time series features and one or more static features. The time series feature may include time-variant features of the user. For example, the time series features may include real-time features (time information, weather information, location information), geographic features (e.g., traffic conditions, demand conditions, supply conditions), application usage information (e.g., number of log-ins to a rider service app in the past week/month, number of orders completed), coupon usage information (e.g., number of coupons provided, number of coupons used, values of coupons used). The static features may include time-invariant features of the user. For example, the static features of the user may include identity information of the user (e.g., user's name, ID number, gender, etc.), vehicle information (e.g., type of car used). Other types of state information are contemplated.

In step S106, upon receiving the computing request, the computing device may feed the state information of the one or more visiting users and an incentive action to the computer model to determine an uplift on at least one performance criterion by providing the incentive action to a target group. The target group may be all of the one or more visiting users or a subgroup of the one or more visiting users. In other words, the target group may include at least one of the one or more visiting users.

In some embodiments, a performance criterion of the platform may be a criterion related to and characterizing the business performance of the platform within a preset time period (e.g., within the previous month). For example, a performance criterion may include, but not limited to, an order amount of the platform, a number of active user (AU) of the platform, cost to the platform, Gross Merchandise Volume (GMV) of the platform, and a gross profit of the platform within a preset time period.

In the example in which the platform is an online ride-hailing platform, the order amount may refer to the total number of ride-hailing orders completed on the platform. The number of AU of the platform may refer to the number of users (e.g., drivers or passengers) who actively using the service of the ride-hailing platform. The GMV of the platform may refer to a total sales monetary value. The gross profit of the platform may refer to the profit the ride-hailing platform makes after deducting the cost associated with the selling of its service.

In some embodiments, the uplift effect may be determined based on more than one performance criteria, and this specification is not limited in this regard.

In this specification, an order amount is used as an exemplary performance criterion. This specification is not limited herein, and other performance criteria may be used without departing from the scope of the specification.

In step S108, based on an order distribution function and a probability of reward, as predicted by the computer model, a cost associated with the incentive action may be determined. The cost associated with an incentive action may refer to a monetary expense to the platform by applying the incentive action to a user, details of which will be described in a later section.

In step S110, based on the uplift on the at least one performance criterion and the cost associated with the incentive action, the computing device may determine whether the incentive action will be applied to the target group.

The uplift on a performance criterion refers to a change in the performance criterion caused by providing the incentive action to the user. That is, the uplift on a performance criterion is the difference between the performance criterion with and without the incentive action being provided to the user. Various methods may be used to determine whether the incentive action will be applied to the visiting user. In some examples, the computing device may determine to apply the incentive action if the uplift on the at least one performance criterion is greater than the cost of the incentive action.

In step S112, upon making the determination that the incentive action will be applied to the target group, the computing device may transmit a return signal to the target group. The return signal may include the incentive action. In one example, the computing device may transmit the return signal to the target group by transmitting the return signal to terminal devices (e.g., smart phones) of the users in the target group.

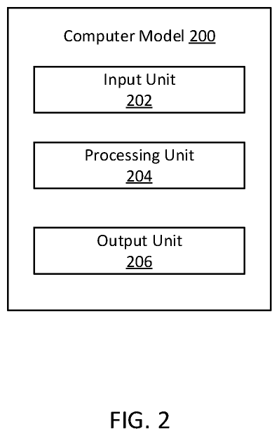

FIG. 2 illustrates a block diagram illustrating a computer model for the computer-implemented method for determining incentive distribution in accordance with various embodiments of this specification.

Referring to FIG. 2, the computer model 200 may include an input unit 202, a processing unit 204, and an output unit 206. These units will be described in greater details later with reference to FIGS. 3A, 3B, and 3C.

The input unit 202 may be configured to obtain the state information of a user of the platform and an incentive action comprising a reward provided by the platform to the user. In one example, the platform may be a ride-hailing platform, and a user of the platform may be a driver and/or a passenger of a vehicle, and the computer model may be configured to obtain state information of the driver and/or the passenger of the vehicle.

In some embodiments, obtaining state information may include one or more of accessing, acquiring, analyzing, determining, examining, loading, locating, opening, receiving, retrieving, reviewing, storing, and/or otherwise obtaining the state information. The computer model may be configured to obtain state information from one or more locations. For example, the computer model may be configured to obtain state information from a storage location, such as electronic storage of the computing device, electronic storage of a device accessible via a network, another computing device/system (e.g., desktop, laptop, smartphone, tablet, mobile device), and/or other locations.

The input unit 202 may be further configured to encode the state information of the user to generate encoded state information and to encode the incentive action to generate an encoded action vector. In this specification, “encode” may refer to a process of converting the format of a signal or data into a format that is acceptable by a neural network. Specific methods and devices for encoding a signal are not limited in this specification.

The processing unit 204 may be configured to determine a first simulation result and a second simulation result based on the encoded state information and the encoded action vector. The first and the second simulation result may both be related to at least one performance criterion of the platform. The first simulation result may be a simulation result of the at least one performance criterion with the incentive action being provided to the user, and the second simulation result may be a simulation result of the at least one performance criterion without an incentive action being provided to the user. In this specification, a “simulation result” may refer to a predicted/estimated result generated by the computer model of this invention.

In some embodiments, the first and the second simulation results may be determined on one performance criterion. In some other embodiments, the first and the second simulation results may be determined on two or more performance criteria. This specification is not limited to this regard.

The processing unit 204 may be further configured to determine a probability of activeness of the user based on the encoded state information and the encoded action vector. The probability of activeness may represent an activity level of the user on the platform.

The processing unit 204 may be further configured to determine a probability of reward for the user based on the first simulation result and a predicted order distribution function. The probability of reward may refer to a probability that the user can actually receive the reward in the incentive action. For example, if the incentive action is a conditional coupon of giving a reward of $3 when the order amount reaches 30 (i.e., a=(30,3)), the probability of reward refers to the probability the user (e.g., a driver or a passenger) meeting the condition of having an order amount of 30 or more to receive the $3 reward. The order distribution function may be a function describing the probability distribution of order amount.

The processing unit 204 may be further configured to output the first and the second simulation results, the probability of activeness, and the probability of reward. The processing unit 204 may further be configured to output other generated and/or derivative results, and this specification is not limited in this regard.

The output unit 206 may be configured to determine an uplift on the at least one performance criterion based on the first and the second simulation results.

FIGS. 3A, 3B, and 3C illustrate diagrams of various computer models for determining incentive distribution, in accordance with various embodiments of the specification. Depending on the number of the performance criterion used for training the computer model, the computer models may be categorized into single-task models and multi-task models. Depending on the specific computation process for the simulation results and basic assumptions underlying the computation process, the computer models may be categorized into deterministic models and stochastic models.

These computer models will be described below in greater details with reference to these drawings. FIG. 3A shows a deterministic single-task model (i.e., a model predicting a simulation result for one performance criterion). In FIG. 3A, an order amount is used as an exemplary performance criterion. Other performance criteria may be used, and this specification is not limited in this regard.

As shown in FIG. 3A, the model may include an input unit 3102, a processing unit 3104, and an output unit 3106.

The input unit 3102 may include one or more encoders. The input unit 3102 may obtain state information of a user of the platform. The state information of a user may be separated into two types of features: the time series features and the static features, each being fed into a corresponding encoder for encoding. Each of the encoders may be a multi-layer neural network (NN) encoder. The NN encoders for regular time series features may be a Recurrent Neural Network (RNN), such as long short-term memory (LSTM) or Gated Recurrent Unit (GRU). Alternatively, the NN encoder for time series features may be a fully-connected (FC) neural network. If an FC neural network is chosen, the time series features may need to be first converted to a vector (e.g., by flattening, or computing a weighted sum, such as mean of time series) before being fed into the FC neural network.

The input unit 3102 may further include an action encoder to encode an incentive action to generate the encoded action vector. In one example, the action encoder may be an FC neural network. In one example, the action encoder may include additional structures, such as embedding/attention, combined with the FC neural network.

After the encoding, the encoded state information may be sent to the processing unit 3104. As shown in FIG. 3A, the processing unit 3104 may include two components: a first component 3111 and a second component 3112, each comprising at least one fully-connected neural network, and being configured to produce the simulation results on the performance criterion based on encoded state information. The first component 3111 may be configured to produce a simulation result with the incentive action being provided to the user (i.e., a first simulation result o₁(s,α) in FIG. 3A) based on the encoded state information of the user and the encoded action vector (“State Feature+Action Encodes” in FIG. 3A). The action vector may include information about the incentive action to be provided to the user and may be produced by a neural network encoder. The second component 3112 may be configured to produce a simulation result without an incentive action being provided to the user (i.e., a second simulation result o₂(s) in FIG. 3A) based on the encoded state information of the user (“State Feature Encodes” in FIG. 3A).

In some embodiments, the first component 3111 and the second component 3112 may each include one or more processing neural networks and one or more final prediction neural networks. The one or more processing neural networks may be configured to generate one or more processed vectors (ϕ₁(s,α) and ϕ₂(s) shown in FIG. 3A) based on the encoded state information and/or the encoded action vector. The one or more final prediction neural networks may each be configured to generate the simulation result on one of the at least one performance criterion (o₁(s,α) and o₂(s) shown in FIG. 3A) based on one of the one or more processed vectors.

In some embodiments, in the processing unit 3104, the simulation results with and without an incentive action being provided may both be generated by the first component 3111. In that case, the processing unit 3104 may produce the simulation result without an incentive action being provided by setting the action vector to be a null vector. That is, the second simulation result may be o₂(s,αₙᵤₗₗ), wherein αₙᵤₗₗ represents a Null vector (i.e., an empty vector) indicating no incentive action being provided.

The computer model may further include an output unit 3106. The output unit may be configured to accept the first and the second simulation results (e.g., o₁ (s,α) and o₂(s) in FIG. 3A) from the processing unit 3104 and determine an uplift on the performance criterion (e.g., order amount). In the computer model shown in FIG. 3A, the uplift uₒ(s,α) may be defined as:

uₒ(s,α)=o₁(s,α)−o₂(s) (1)

Based on the uplift on the performance criterion and a cost associated with the incentive action, the computing device may determine whether the incentive action will be applied to the user.

Incentive actions may each have an associated cost. The cost of an incentive action may refer to a monetary cost to the platform by applying the incentive action to a user. For example, when the incentive action is providing a coupon to a driver or a passenger of a vehicle, the cost of the incentive action is the value of the coupon. The cost associated with an incentive may be a fixed cost (e.g., for a fix-amount coupon), a variable cost (e.g., for a variable amount coupon, such as a percentage off coupon). Additionally, the cost for an incentive action may also include implicit costs such as an effect to user experience or implicit risk to cash flow.

In one example, the incentive action may be providing a tiered coupon (i.e., a=[(x₁,y₁), (x₂,y₂), . . . , (xₙ,yₙ)]), and the cost R of the incentive action may be expressed as:

R=Σᵢ₌₁ⁿ⁻¹yᵢ(α)Iₓ_{ᵢ}_{≤o(s,α)≤x}_{ᵢ₊₁})+yₙ(α)Iₓ_{ₙ}_{≤o(s,α)} (2)

wherein I(⋅) is an indicator function, which has the value of 1 if the subscript event happens, and 0 otherwise.

Whether an incentive action will be applied to a user may be determined based on the uplift on the at least one performance criterion and the associated cost. In one example, when the uplift of the incentive action is greater than the cost, it may be determined that the incentive action will be applied to the user. Other criteria may be used, and this specification is not limited in this regard.

FIG. 3B shows a deterministic computer model for multiple performance criteria. The computer model in FIG. 3B is configured to produce simulation results on two performance criteria (i.e., the order amount and the GMV). For each performance criteria, the corresponding simulation result may include a result with an incentive action being provided and a result without an incentive action being provided. For example, as shown in FIG. 3B, the first simulation result may include simulated order amount (i.e., o₁(s,α)) and simulated GMV (i.e., g₁(s,α)) with the incentive action being provided to the user, and the second simulation result may include simulated order amount (i.e., o₂(s)) and simulated GMV (i.e., g₂(s)) without an incentive action being provided to the user.

The deterministic computer model for multiple performance criteria may include an input unit 3202, a processing unit 3204, and an output unit 3206. The input unit 3202 may be the same as the input unit 3102 in the single-task computer model shown in FIG. 3A. The relevant description for the single-task model in FIG. 3A may be referred to for details, which will not be repeatedly presented herein for the sake of conciseness.

The processing unit 3204 may include a first component 3211 and a second component 3212. The first component 3211 may be configured to produce a simulation result with the incentive action being provided to the user based on the encoded state information of the user and the encoded action vector (“State Feature+Action Encodes” in FIG. 3B). The second component 3212 may be configured to produce a simulation result without an incentive action being provided to the user based on the encoded state information of the user (“State Feature Encodes” in FIG. 3B).

Compared with the single-task model shown in FIG. 3A, each of the first component 3211 and the second component 3212 in the processing unit 3204 of the multi-task model may include additional neural networks to produce simulation results for multiple performance criteria. In the multi-task computer model shown in FIG. 3B, the simulation results are produced on two performance criteria (i.e., order amount and GMV). By adding neural networks on the first component and the second component on the processing unit of a multi-task computer model, the model may be configured to produce simulation results on more than two (e.g., three, four, or five) performance criteria, and this specification is not limited in this regard.

In some embodiments, the first component 3211 and the second component 3212 may each include one or more processing neural networks and one or more final prediction neural networks. The one or more processing neural networks may be configured to generate one or more processed vectors (ϕ′₁(s,α), ϕ₁(s,α), ϕ′₂(s) and ϕ₂(s) shown in FIG. 3B) based on the encoded state information and/or the encoded action vector. The one or more final prediction neural networks may each be configured to generate the simulation result on one of the at least one performance criterion (o₁(s,α), o₂ (s), g₁(s,α), and g₂(s) shown in FIG. 3B) based on one of the one or more processed vectors.

FIG. 3C shows a stochastic multi-task computer model for multiple performance criteria. The stochastic model computes the simulation results on the performance criterion based on a statistical distribution of the order amount and/or the probability that a user (e.g., a driver of a vehicle) being an active user of the platform.

As shown in FIG. 3C, the stochastic multi-task model may include an input unit 3302, a processing unit 3304, and an output unit 3306. The input unit 3302 may be the same as the input unit 3102 in the single-task computer model shown in FIG. 3A. The relevant description for the single-task model in FIG. 3A may be referred to for details, which will not be repeatedly presented herein for the sake of conciseness.

The processing unit 3304 may be similar to the processing unit 3204 in the multi-task model shown in FIG. 3B. That is, the processing unit 3304 may include a first component 3311 and a second component 3312. The first component 3311 may be configured to produce a simulation result with the incentive action being provided to the user based on the encoded state information of the user and the encoded action vector (“State Feature+Action Encodes” in FIG. 3C) and. The second component 3312 may be configured to produce a simulation result without an incentive action being provided to the user based on the encoded state information of the user (“State Feature Encodes” in FIG. 3C).

In some embodiments, the first component 3311 and the second component 3312 may each include one or more processing neural networks and one or more final prediction neural networks. The one or more processing neural networks may be configured to generate one or more processed vectors ϕ′₁(s,α), ϕ₁(s,α), ϕ′₂(s) and ϕ₂(s) shown in FIG. 3B) based on the encoded state information and/or the encoded action vector. The one or more final prediction neural networks may each be configured to generate the simulation result on one of the at least one performance criterion (o₁(s,α), o₂(s), g₁(s,α), and g₂(s) shown in FIG. 3B) based on one of the one or more processed vectors.

Compared to the deterministic multi-task model shown in FIG. 3B, the stochastic multi-task model shown in FIG. 3C computes the simulation result on the performance criterion based on one or more of: a statistical distribution of the order amount, a probability of reward, and whether the user is an active user of the platform.

For example, using the performance criterion being an order amount as an example, the first simulation result with an incentive action being provided (i.e., oᵢ(s,α)), and the second simulation result without an incentive action being provided (i.e., o₂(s)) may be expressed, respectively, as:

o₁(s,α)=E(O₁|s,α,active) (3)

o₂(s)=E(O₂|s,active) (4)

wherein E(⋅) represents an expected value, Oᵢ is a distribution function of order amount with (i=1) or without (i=0) an incentive action being provided. The parameter active indicates the user (e.g., a driver of a vehicle) being an active user of the platform during a time period the incentive action is applicable to. The criterion to determine whether a user is an active user may be chosen according to specific needs and is not limited in this specification. In one example, a user may be determined to be active if a number of orders completed within a set period of time are larger than a preset threshold, such as zero.

Based on Equations (3) and (4) above, the uplift on the order amount for the stochastic model may be expressed as:

$${u}_{0} ( s , a ) = E ( {O}_{1} \vert s , a ) - E ( {O}_{2} \vert s ) = E ( {O}_{1} \vert s , a , active ) P ( active \vert s , a ) + 0 - E ( {O}_{2} \vert s , active ) P ( active \vert s ) - 0 = {o}_{1} ( s , a ) P ( active \vert s , a ) - {o}_{2} ( s ) P ( active \vert s ) \qquad ( 5 )$$

wherein P(active|s,α) and P(active|s) are the probability that the user with state information of s being an active user with and without an incentive action α being provided, respectively. The uplifts on other performance criteria may be computed using the computation process described above. For example, the uplift on the GMV may be computed using Equation (5) by replacing the prediction results on order amount (i.e., o₁(s,α) and o₂(s)) with prediction results on GMV (i.e., g₁(s,α) and g₂(s)). Computation processes for other performance criteria are omitted herein for the sake of conciseness.

In the stochastic model, the cost associated with an incentive action may be computed based on a distribution function of the order amount (assuming the order amount is used as the performance criterion). In one example, the distribution function of order amount may be set to be the Gumbel function, and be expressed as:

O₁|active˜Gumbel(μ₁,β₁) (6)

wherein μ₁ and β₁ are parameters of the Gumbel distribution. Other distribution functions may be used according to a specific circumstance, and this specification is not limited in this regard.

Given the Euler-Mascheroni constant γ≈0.5772, and assuming the parameter β₁ is a constant, the order amount assuming an incentive action being provided may be expressed as (assuming the distribution of order amount follows the Gumbel distribution of Equation (6)):

o₁(s,α)=E(O₁|s,α,active)=μ₁−γβ₁ (7)

μ₁(s,α)=o₁(s,α)+γβ₁ (8)

The cumulative distribution function (CDF) of the order amount may be expressed as:

Fₒ_{₁}(⋅|μ₁(s,α),βᵢ,active), or

Fₒ_{₁}(⋅|s,α,active), and β₁ is a predefined and fixed constant.

For an order following Gumbel distribution, the CDF of the order is:

$${F}_{{o}_{1}} ( z \vert s , a , active ) = 1 - exp ( - exp \frac{z - {μ}_{1}}{{β}_{1}} ) = 1 - exp ( - exp ( \frac{z - {o}_{1} ( s , a )}{{β}_{1}} - γ ) ) \qquad ( 9 )$$

wherein z represents an order amount.

In some embodiments, the incentive action may be a tiered coupon. The probability of a driver receiving a reward q(s,α) is related to the probability the order amount reaches the lowest order amount to receive a reward in the tiered coupon and may be expressed as:

q(s,α)=P(O₁≥x₁(α)|s,α,active)=1−Fₒ_{₁}(x₁(α)|s,α,active) (10)

wherein P(⋅) represents a probability of the underlying event, x₁(α) is the lowest order amount to receive a reward in the tiered coupon.

The expected cost of the tiered coupon E may be expressed as:

E(R|s,α,active)≈q(s,α)·y₁(α) (11)

E(R|s,α)=E(R|s,α,active)P(active|s,α)+0·P(inactive|s,α)≈P(active|s,α)q(s,α)y₁(α) (12)

wherein y₁(α) is the reward the user will receive when the order amount reaches x₁(α), and P(active|s,α) represents a probability the user with state information of s be an active user when the incentive action α is provided to the user.

In Equation (11), it is assumed that the gap between different rewards in a tiered coupon (i.e., yᵢ, i=1, 2, . . . ) is small compared to the first reward (i.e., y₁). Therefore, it is implicitly assumed that y₁≈y₂≈ . . . ≈yₙ, n is the total number of tiers in a tiered coupon. Equation (11) may be referred to as the “first approximation” of the probability of reward in this specification.

To more accurately estimate the cost associated with a tiered coupon, a probability of a driver receives a specific level of reward qᵢ(s,α) may be computed by:

$${q}_{i} ( s , a ) = P ( receiving ith level reward \vert s , a , active ) = P ( {x}_{i + 1} ( a ) > {O}_{1} \geq {x}_{i} ( a ) \vert s , a , active ) = {F}_{{o}_{1}} ( {x}_{i + 1} ( a ) \vert s , a , active ) - {F}_{{o}_{1}} ( {x}_{i} ( a ) \vert s , a , active ) \qquad ( 13 )$$

Equation (13) may be referred to as the “second approximation” of the probability of reward in this specification. Then the estimated cost associated with a tiered coupon may be expressed as:

E(R|s,α,active)=Σᵢqᵢ(s,α)yᵢ(α) (14)

E(R|s,α)=E(R|s,α,active)P(active|s,α)=P(active|s,α)Σᵢqᵢ(s,α)yᵢ(α) (15)

In some embodiments, the aforementioned method for determining incentive distribution may further include training the computer model using historical records of the platform. As described above, the computer model for determining incentive distribution may include one or more neural networks each comprising a plurality of parameters. The neural networks may be fully-connected neural networks comprising a plurality of neurons each associated with a weight, and the plurality of parameters may be the weights associated with the neurons.

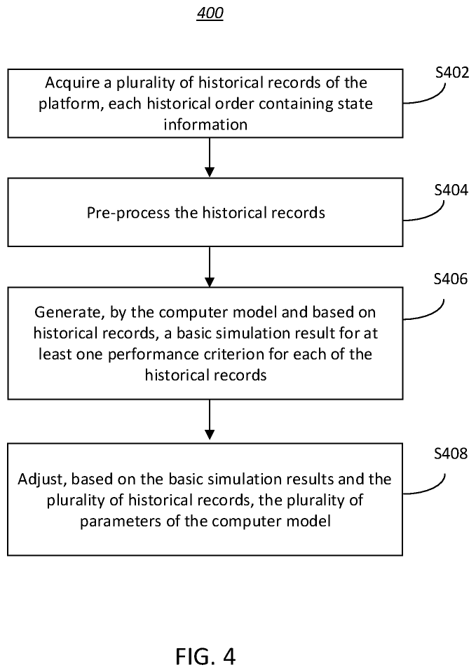

FIG. 4 illustrates a flow chart of a method for training the computer model for determining incentive distribution in accordance with various embodiments of the specification. As shown in FIG. 4, the method for training the computer model 400 may include the following step S402 through S408.

In step S402, a plurality of historical records of the platform may be acquired. Each historical record may contain the state information. The historical records of the platform may be related to previous orders of the platform received within a preset period of time. For example, the historical records may the related to orders the platform received within last month or last year.

Specific conditions may be set when acquiring the historical records for training the computer model. In one example, the historical records may be acquired based on previous orders the platform received within a specific geographic area (e.g., in a specific city) and/or in a specific time range of a day (e.g., in the morning). In another example, the historical records may be acquired based on a specific group of users (e.g., users who are 40-50 years old, or who have placed at least 10 orders). Specific manners of acquiring the historical records are not limited in this specification.

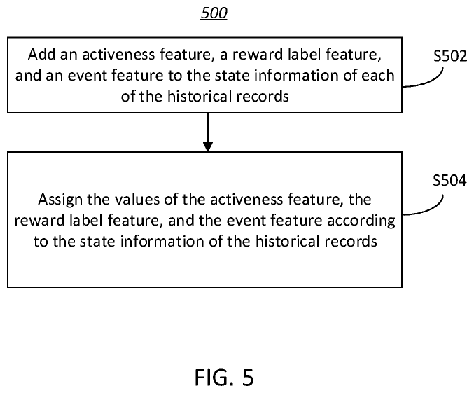

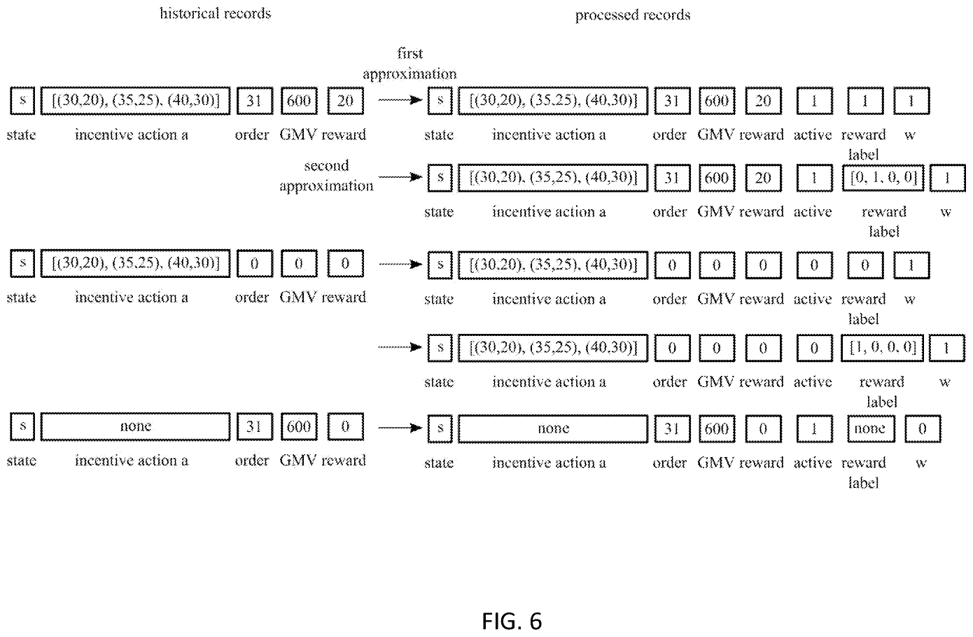

In step S404, the historical records may be pre-processed. Details of the pre-processing process of the historical records are described below with reference to FIGS. 5 and 6.

FIG. 5 illustrates a flow chart illustrating the pre-processing of historical records in accordance with various embodiments of the specification. FIG. 6 illustrates an example showing the pre-process of the historical records for training the computer model, in accordance with various embodiments of the specification.

Referring to FIG. 5, the pre-processing of the historical records may include the following steps S502 and S504.

In step S502, for each historical record, an activeness feature, a reward label feature, and an action feature may be added to the state information of the historical record.

As shown in FIG. 6, in one example, the state information of a historical record may originally include a state feature (s), an incentive action feature (a), an order amount feature (order), a GMV feature (GMV), and a reward feature (reward). Each feature records the corresponding information associated with this historical record. For example, as shown in FIG. 6, the first historical record has a value of [(30,20), (35,25), (40,30)] in the incentive action feature, indicating a tiered coupon was provided as an incentive action. It has a value of 31 in the order amount feature, a value of 600 in the GMV, and a value of 20 in the reward feature, indicating the order amount, the GMV, and the received reward are 31, $600, and $20, respectively.

The pre-processing of the historical records may include adding an activeness feature (active), a reward label feature (reward label), and an event feature (w) to the state information of each of the plurality of historical records. The activeness feature (active) may have a binary value indicating whether the user is an active user. In one example, it may have a value of 1 if the user has a positive order amount, and 0 otherwise. The reward label feature (reward label) may have a binary value indicating whether the user has received a reward in this record. The event feature (w) has a binary value and represents whether an incentive action has been provided in this record. It may have a value of 1 if an incentive action was provided (the reward in the incentive action does not need to be actually received), and a value 0 otherwise. Adding these additional features to the state information of the historical records allows the computer model to be more accurately trained.

In some embodiments, when a tiered coupon was provided as an incentive action to a historical record, the reward label feature (reward label) may be either a single binary value when the first approximation is used for the probability of reward, or a vector of binary values, each indicating a specific level of reward received for this order, when the second approximation is used for the probability of reward.

Referring back to FIG. 5, in step S504, the values for the activeness feature, the reward label feature, and the event feature for each historical record may be assigned according to the state information of the historical records.

Referring back to FIG. 4, in step S406, based on the historical records, a basic simulation result for the at least one performance criterion may be generated for each of the plurality of historical records by the computer model.

In step S408, based on the basic simulation results and the plurality of historical records, the plurality of parameters of the computer model may be adjusted.

The plurality of parameters of the computer model may be adjusted on the basis that the adjusted parameters may result in a satisfying match between the basic simulation results and corresponding actual results from the historical records. That is, the parameters may be adjusted on the basis that the difference (known as the “loss function”) between the basic simulation results and the actual results is within an acceptable range.

The loss function Lₗₒₛₛ between the basic simulation results and actual results may be mean square error (MSE), mean absolute error (MAE), or Huber loss between the basic simulation results and the actual results. This specification, however, is not limited in this regard. Any criterion/function that can reflect the difference between simulations results and actual results may be used as a loss function.

In one example, for a deterministic model (such as the models shown in FIGS. 3A and 3B), the loss function (i.e., the basic loss, L_{basic}) may be MSE between the basic simulation results and the actual results, and may be described as:

$${L}_{b a s i c} = \frac{1}{n} {\sum }_{i} ( {( {[ {o}_{t} ( {s}_{i} , {a}_{i} , {ω}_{i} ) - {o}_{i} ]}^{+} )}^{2} + {r ( {[ {o}_{t} ( {s}_{i} , {a}_{i} , {ω}_{i} ) - {o}_{i} ]}^{-} )}^{2} ) \qquad ( 16 )$$

wherein the summation Σ is conducted on all the historical records. Subscript i means the i-th record in the historical records, oᵢ is the i-th actual result, oᵢ is the corresponding basic simulation results generated by the computer model. (⋅)⁺ means truncating negative value within the parenthesis to 0, and (⋅)⁻ means truncating positive value within the parenthesis to 0. ωᵢ is the event feature for the i-th historical record, which has a value of 1 if an incentive action is provided and 0 otherwise.

The value of r represents how the positive and negative differences between simulation results and true results are respectively weighted when computing MSE. When r=1, standard MSE is used, positive and negative differences between simulation results and true results are given the same weight. When r<1, over-estimation is penalized more; when r>1, under-estimation is penalized more. In some embodiments, to alleviate under-estimation of the cost, the r value that slightly penalizes under-estimation (i.e., r>1) may be chosen.

In the example described above, when a deterministic model is used, oₜ may be expressed as:

oₜ(s,α,ω)=ωo₁(s,α)+(1−ω)o₂(s) (17)

Alternatively, when a stochastic model is used, o_{f} may be expressed as:

oₜ(s,α,ω)=ωo₁(s,α)P(active|s,α)+(1−ω)o₂(s)P(active|s) (18)

In some embodiments, the training of the computer model may take into consideration the counter-factual balance on the training data. When training the computer model using historical records, each of the historical records may represent a determined scenario with or without an incentive action being provided. However, to effectively evaluate the uplift of an incentive action on a performance criterion of the platform, comparison needs to be made between historical records with similar state information but different incentive actions (e.g., between similar orders with and without the incentive action being provided). In this specification, counter-factual balance may refer to the balancing of training data to provide simulation results from historical records having similar state information but different incentive actions.

To address the counter-factual balance, the training of the compute model may further include: grouping, based on the state information of the plurality of historical records, the historical records into a plurality of counter-factual pairs. Each counter-factual pair may include a first historical record with an incentive action being provided, and a second historical record with no incentive action being provided. The first historical record and the second historical record within a counter-factual pair may have similar state information. The training of the computer model may further include: determining, for each historical record in each counter-factual pair, a counter-factual simulation result; and adjusting the parameters of the computer model based on a difference between each of the historical records and corresponding counter-factual simulation result.

More specifically, in the plurality of historical records acquired, for each historical record, a counter-factual counterpart may be found. That is, for each historical record with an incentive action, a counterpart order that has a similar state but has opposing incentive action may be found within the plurality of historical records. For example, for a historical record having a state feature of sᵢ, and an incentive action feature of αᵢ, with αᵢ being an incentive action being provided, a counterpart order that has a state feature sⱼ and an incentive action feature of αⱼ may be found. State feature sⱼ may be similar to sᵢ, and αⱼ is an opposing incentive action to αᵢ. (i.e., αⱼ is no incentive action is provided). Similarly, for each historical record with no incentive action, a counterpart order that has a similar state with an incentive action being provided may be found within the plurality of historical records. Each pair of the foregoing historical records may form a counter-factual pair.

Assuming one historical record in a counter-factual pair has an index of i, the index of the other order in the counter-factual pair may be denoted as c(i). The loss function may further include the difference between the counter-factual simulation results and actual results.

More specifically, the loss function with respect to the counter-factual balance may be expressed as:

$${L}_{balance} = \frac{1}{n} {\sum }_{i} ( \vert {o}_{t} ( {s}_{i} , {a}_{i} , {ω}_{i} ) - {o}_{i} \vert + γ \vert {o}_{c f} ( {s}_{i} , {a}_{i} , {ω}_{i} ) - {o}_{c ( i )} \vert ) \qquad ( 19 )$$

wherein the summation Σ is conducted on all the historical records, γ is the weight of counter-factual part in the loss, and o_{cf}(sᵢ,αᵢ,ωᵢ) is the counter-factual simulation result corresponding to i^{th} order in the historical records. The specific expression of the simulation result o_{cf} (sᵢ,αᵢ,ωᵢ) may be related to whether a deterministic model or a stochastic model is used. If a deterministic model is used,

o_{c}_{_{f}}(sᵢ,αᵢ,ωᵢ)=ωᵢo₂(sᵢ)+(1−ωᵢ)o₁(sᵢ,αᵢ) (20)

If a stochastic model is used,

o_{c}_{_{f}}(sᵢ,αᵢ,ωᵢ),ωᵢo₂(sᵢ)P(active|sᵢ)+(1−ωᵢ)oᵢ(sᵢ,αᵢ)P(active|sᵢ,αᵢ) (21)

Additionally, the loss function for training the computer model may further include a distribution discrepancy. The distribution discrepancy may refer to a disproportion between the training data with and without an incentive action being provided. The distribution discrepancy between the o₁ predictions and the o₂ predictions may be expressed as a function of processed vector (e.g., Ø₁(s,α) and Ø₂(s), shown in FIG. 3A) corresponding to model output o₁(sᵢ,αᵢ) and o₂(sᵢ), respectively. The distributional discrepancy between the o₁ predictions and the o₂ predictions over training data may be expressed as a functions of Øᵢ, and can be expressed as:

$${L}_{dist - discrepancy} = p - \frac{1}{2} + \sqrt{{( p - \frac{1}{2} )}^{2} + {‖ p \frac{1}{n} {\sum }_{i = 1}^{n} {∅}_{1} ( {s}_{i} , {a}_{i} ) - ( 1 - p ) {\sum }_{i = 1}^{n} {∅}_{2} ( {s}_{i} ) ‖}_{2}^{2}} \qquad ( 22 )$$

wherein p can be estimated as the portion of entries with ω=1 in the training data set (e.g., historical records), and ∥⋅∥₂ is the l₂ norm (i.e., Euclidean Norm) of a vector.

In some embodiments, the computer model may be trained either separately for individual performance criterion (e.g., order amount, GMV, etc.). In some other embodiments, the computer model may be trained for multiple performance criteria simultaneously.

For a computer model trained for individual performance criterion, the loss function may be:

L=L_{basic}+βL_{balance}+αL_{dist-discrepancy} (23)

wherein β and α are the relative weight of the counter-factual balance loss and distribution discrepancy loss, respectively, to the basic loss. Values of these parameters may be adjusted according to specific needs, and are not limited in this specification.

For a computer model trained for multiple performance criteria, relative weights of different performance criteria in the computer model may be selected according to specific need. For example, in a computer model trained for two performance criteria (e.g., order amount and GMV) as an example, the loss function may be:

L=L_{basic}^{order}+β₁L_{balance}^{order}+α₁L_{dist-discrepancy}^{order}+η(L_{basic}^{GMV}+β₂L_{balance}^{GMV}+α₂L_{dist- discrepancy}^{GMV} (24)

wherein η is the relative weight between these two performance criteria (i.e., GMV and order amount), and may be determined according to specific needs. βᵢ and αᵢ (i=1, 2) are the relative weights of the counter-factual balance loss and distribution discrepancy loss, respectively, for the i^{th} performance criterion.

When a stochastic model is used, two more elements need to be added to the loss function: a probability of reward and a probability of activeness. The loss function may be expressed as:

L=L_{basic}^{order}+β₁L_{balance}^{order}+α₁L_{dist-discrepancy}^{order}+η₁(L_{basic}^{GMV}+β₂L_{balance}^{GMV}+α₂L_{dist-discrepancy}^{GMV})+η₂L_{reward}+η₃L_{active} (25)

wherein ηᵢ (i=1, 2, 3) is the relative weight of the corresponding element. The formula for L_{reward} may be determined depending on whether the first approximation or the second approximation to the probability of reward is used. If the first approximation to the probability of reward is used, the loss function may be expressed, by using binary cross-entropy, as:

$${L}_{reward} = - \frac{1}{n} {\sum }_{i ∈ \{ k \vert k = 1 , … , n and {w}_{k} = 1 \}} {d}_{i} ln ( P ( active \vert {s}_{i} , {a}_{i} ) q ( {s}_{i} , {a}_{i} ) ) + ( 1 - {d}_{i} ) ln ( 1 - P ( active \vert {s}_{i} , {a}_{i} ) q ( {s}_{i} , {a}_{i} ) ) \qquad ( 26 )$$

wherein dᵢ is a label reflecting whether feature receives a reward or not (dᵢ=1 means a reward was given) and q(s,α) is the predicated probability of reward given an activeness status of the user.

If the second approximation to the probability of reward is used, the loss function may be expressed, by using categorical cross-entropy, as:

$${L}_{reward} = - \frac{1}{n} {\sum }_{i ∈ \{ k \vert k = 1 , … , n and {w}_{k} = 1 \}} {\sum }_{j = 0}^{m} {d}_{i j} ln ( {\tilde{q}}_{j} ( {s}_{i} , {a}_{i} ) ) \qquad ( 27 )$$

wherein dᵢⱼ is the label vector for the reward level (dᵢⱼ=1 means a reward from the jth level. 0^{th} level means no reward), and there are m layers of reward. And \tilde{q}ⱼ (sᵢ,αᵢ) has the value of:

[symbol]

(sᵢ,αᵢ)=1−P(active|sᵢ,αᵢ)Σⱼ₌₁^{m}qⱼ(sᵢ,αᵢ) (28)

[symbol]

(sᵢ,αᵢ)=P(active|sᵢ,αᵢ)qⱼ(sᵢ,αᵢ),j=1,2, . . . ,m (29)

For the probability of activeness, L_{active} can be expressed as:

$${L}_{active} = - \frac{1}{n} {\sum }_{i ∈ \{ k \vert k = 1 , … , n and {w}_{k} = 1 \}} {b}_{i} ln ( P ( active \vert {s}_{i} , {a}_{i} ) ) + ( 1 - {b}_{i} ) ln ( 1 - P ( active \vert {s}_{i} , {a}_{i} ) ) \qquad ( 30 )$$

This concludes the descriptions of the methods for determining incentive distribution in accordance with various embodiments of this specification. By evaluating the uplift effect based on statistical distribution of the order and reward, the activeness of the user, and counter-factual balance of the data, the method improves the accuracy of the uplift prediction, thereby improving efficiency and accuracy of the incentive distribution.

Based on the aforementioned system and method embodiments, this specification further presents a computer device. The computer device may include a processor coupled with a non-transitory computer-readable storage medium. The storage medium may store instructions executable by the processor. Upon being executed by the processor, the instructions may cause the processor to perform operations.

The operations may include: obtaining a computer model. The computer model may include an input unit, a processing unit, and an output unit.

The input unit may be configured to: obtain state information of a user of an online platform, obtain an incentive action comprising a reward provided by the online platform to the user, encode the state information of the user to generate encoded state information, and encode the incentive action to generate an encoded action vector.

The processing unit may be configured to: determine, based on the encoded state information and the encoded action vector, a first simulation result of at least one performance criterion of the online platform with the incentive action being provided to the user, a second simulation result of the at least one performance criterion of the online platform without an incentive action being provided to the user, and a probability of activeness of the user using the online platform, determine, based on the first simulation result and an order distribution function, a probability of reward representing a probability of the user receiving the reward in the incentive action, and output the first and the second simulation results, the probability of activeness, and the probability of reward.

The output unit may be configured to: determine, based on the first and the second simulation results, the probability of activeness, and the probability of reward, an uplift on the at least one performance criterion of providing the incentive action to the user.

The operations may further include: receiving, by the computing device, a computing request related to one or more visiting users visiting the online platform, wherein the computing request comprises state information of the one or more visiting users; determining, by feeding the state information of the one or more visiting users and one or more incentive actions to the computer model, an uplift on the at least one performance criterion of providing each of the one or more incentive actions to a target group, the target group comprising at least one of the one or more visiting users; determining, based on an uplift on the at least one performance criterion, one of the one or more incentive actions to be applied to the target group; and transmitting, by the computing device, a return signal to the target group, the return signal comprising the one incentive action.

Additionally, the operations may further include one or more steps in any one of the aforementioned method embodiments. Relevant part in the method embodiments may be referred to for details, which will not be repeatedly present here for the sake of conciseness.

Based on the aforementioned system and method embodiments, this specification further presents a non-transitory computer-readable storage medium. The storage medium may store instructions executable by a processor. Upon being executed by a processor, the instructions may cause the processor to perform any one or more steps in any one of the aforementioned method embodiments.

This specification further presents a computer system for implementing the method for determining incentive distribution in accordance with various embodiments of this specification.

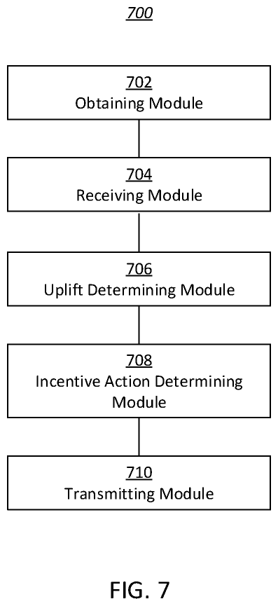

FIG. 7 illustrates a block diagram of a computer system 700 for determining incentive distribution, in accordance with various embodiments. The system 700 may be an exemplary implementation of the method 100 of FIG. 1 or one or more devices performing the method 100. The computer system 700 may include one or more processors and one or more non-transitory computer-readable storage media (e.g., one or more memories) coupled to the one or more processors and configured with instructions executable by the one or more processors to cause the system or device (e.g., the processor) to perform the method 100. The computer system 700 may include various units/modules corresponding to the instructions (e.g., software instructions). In some embodiments, the instructions may correspond to a software such as a desktop software or an application (APP) installed on a mobile phone, pad, etc.

In some embodiments, the computer system 700 may include an obtaining module 702, a receiving module 704, an uplift determining module 706, an incentive action determining module 708, and a transmitting module 710.

The obtaining module 702 may be configured to obtain a computer model. The computer model may include an input unit, a processing unit, and an output unit.

The input unit may be configured to: obtain state information of a user of an online platform, obtain an incentive action comprising a reward provided by the online platform to the user, encode the state information of the user to generate encoded state information, and encode the incentive action to generate an encoded action vector. The processing unit may be configured to: determine, based on the encoded state information and the encoded action vector, a first simulation result of at least one performance criterion of the online platform with the incentive action being provided to the user, a second simulation result of the at least one performance criterion of the online platform without an incentive action being provided to the user, and a probability of activeness of the user using the online platform, determine, based on the first simulation result and an order distribution function, a probability of reward representing a probability of the user receiving the reward in the incentive action, and output the first and the second simulation results, the probability of activeness, and the probability of reward. The output unit may be configured to: determine, based on the first and the second simulation results, the probability of activeness, and the probability of reward, an uplift on the at least one performance criterion of providing the incentive action to the user.

The receiving module 704 may be configured to receive a computing request related to one or more visiting users visiting the online platform. The computing request may include state information of the one or more visiting users.

The uplift determining module 706 may be configured to determine, by feeding the state information of the one or more visiting users and one or more incentive actions to the computer model, an uplift on the at least one performance criterion of providing each of the one or more incentive actions to a target group. The target group may include at least one of the one or more visiting users.

The incentive action determining module 708 may be configured to determine, based on an uplift on the at least one performance criterion, one of the one or more incentive actions to be applied to the target group.

The transmitting module 710 may be configured to transmit a return signal to the target group. The return signal may include the one incentive action, and may be transmitted to terminal devices (e.g., smart phones) of the target group.

This specification further presents another computer system for implementing the method for determining incentive distribution in accordance with various embodiments of this specification.

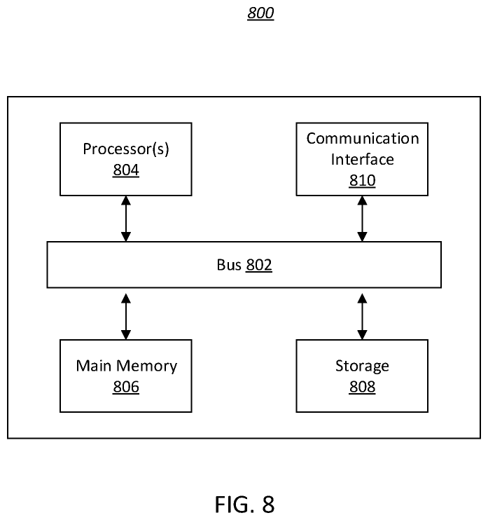

FIG. 8 is a block diagram that illustrates a computer system 800 upon which any of the embodiments described herein may be implemented. The computer system 800 includes a bus 802 or other communication mechanisms for communicating information, one or more hardware processors 804 coupled with bus 802 for processing information. Hardware processor(s) 804 may be, for example, one or more general purpose microprocessors.

The computer system 800 also includes a main memory 806, such as a random access memory (RAM), cache, and/or other dynamic storage devices, coupled to bus 802 for storing information and instructions to be executed by processor(s) 804. Main memory 806 also may be used for storing temporary variables or other intermediate information during execution of instructions to be executed by processor(s) 804. Such instructions, when stored in storage media accessible to processor(s) 804, render computer system 800 into a special-purpose machine that is customized to perform the operations specified in the instructions. Main memory 806 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 808. Execution of the sequences of instructions contained in main memory 806 causes processor(s) 804 to perform the method steps described herein. For example, the method steps shown in FIGS. 1 and 4 and described in connection with these drawings can be implemented by computer program instructions stored in main memory 806. When these instructions are executed by processor(s) 804, they may perform the steps as shown in FIGS. 1 and 4 and described above. In alternative embodiments, hard-wired circuitry may be used in place of or in combination with software instructions.

The computer system 800 may also include a communication interface 810 coupled to bus 802. Communication interface 810 may provide a two-way data communication coupling to one or more network links that are connected to one or more networks. As another example, communication interface 810 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner).

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

1. A computer-implemented method, comprising:
obtaining, by a computing device, a computer model, wherein:
the computer model comprises an input unit, a processing unit, and an output unit,
the input unit is configured to:
obtain state information of a user of an online platform,
obtain an incentive action comprising a reward provided by the online platform to the user,
encode the state information of the user to generate encoded state information, and
encode the incentive action to generate an encoded action vector,
the processing unit is configured to:
determine, based on the encoded state information and the encoded action vector, a first simulation result of at least one performance criterion of the online platform with the incentive action being provided to the user, a second simulation result of the at least one performance criterion of the online platform with no incentive action being provided to the user, and a probability of activeness of the user using the online platform,
determine, based on the first simulation result and an order distribution function, a probability of reward representing a probability of the user receiving the reward in the incentive action, and
output the first and the second simulation results, the probability of activeness, and the probability of reward,
the output unit is configured to:
determine, based on the first and the second simulation results, the probability of activeness, and the probability of reward, an uplift on the at least one performance criterion of providing the incentive action to the user;
training, based on a plurality of historical records of the online platform, the computer model by:
generating, based on the historical records, test results for the at least one performance criterion corresponding to the plurality of historical records; and
adjusting, based on the test results and a loss function, a plurality of parameters of the computer model,
wherein the historical records include a plurality of counter-factual pairs each comprising a first historical record with a historical incentive action being provided and a second historical record with no historical incentive action being provided, the first historical record and the second historical record having similar state information, and
wherein the loss function includes a linear combination of a counter-factual loss function and a distribution discrepancy loss function, the counter-factual loss function including a summation of a difference between the test results of the first and the second historical records in the counter-factual pairs, the distribution discrepancy function reflecting a disproportion between the first historical records and the second historical records;
receiving, by the computing device, a computing request related to one or more visiting users visiting the online platform, wherein the computing request comprises state information of the one or more visiting users;
determining, by feeding the state information of the one or more visiting users and one or more candidate incentive actions to the trained computer model, an uplift on the at least one performance criterion of providing each of the one or more candidate incentive actions to a target group, the target group comprising at least one of the one or more visiting users;
determining, based on the uplift on the at least one performance criterion, one of the one or more candidate incentive actions to be applied to the target group; and
transmitting, by the computing device, a return signal to the target group, the return signal comprising the one of the one or more candidate incentive actions.

2. The method of claim 1, wherein determining one of the one or more candidate incentive actions to be applied to the target group comprises:
Determining, based on the probability of reward and the order distribution function, a cost associated with each of the one or more candidate incentive actions; and
determining, based on the uplift on the at least one performance criterion and the cost associated with each of the candidate incentive actions, the one of the one or more candidate incentive actions to be applied to the target group.

3. The method of claim 2, wherein the online platform is a ride-hailing platform, each of the one or more candidate incentive actions is a tiered coupon including a plurality of rewards each corresponding to one of a plurality of threshold order amounts, and
wherein determining the cost associated with each of the one or more candidate incentive actions comprises:
determining, based on the order distribution function, a tiered reward probability for each of the plurality of rewards in the tiered coupon; and
determining, based on the tiered reward probability for each of the plurality of rewards in the tiered coupon, the cost associated with each of the one or more candidate incentive actions.

4. The method of claim 1, wherein:
the state information of the user includes one or more series features of the user and one or more static features of the user;
the one or more time series features include one or more of the following:
time information,
weather information,
location information, and
traffic condition information; and
the one or more static features include one or more of the following:
a name of the user,
a gender of the user, and
vehicle information.

5. The method of claim 1, wherein
the processing unit includes a first component and a second component each comprising one or more neural networks;
the first component is configured to generate the first simulation result based on the encoded state information and the encoded action vector; and
the second component is configured to generate the second simulation result based on the encoded state information.

6. The method of claim 5, wherein:
the first component includes one or more first processing neural networks and one or more first prediction neural networks, the one or more first processing neural networks are configured to generate one or more first processed vectors corresponding to the first simulation result based on the encoded state information and the encoded action vector, and the one or more first prediction neural networks are configured to generate the first simulation result based on the one or more first processed vectors, and
the second component includes one or more second processing neural networks and one or more second prediction neural networks, the one or more second processing neural networks are configured to generate one or more second processed vectors corresponding to the second simulation result based on the encoded state information, and the one or more second prediction neural networks are configured to generate the second simulation result based on the one or more second processed vectors.

7. The method of claim 1, wherein the online platform is a ride-hailing platform, and the user is a driver of a vehicle or a passenger seeking transportation in a vehicle, and the at least one performance criterion comprises one or more of the following within a preset period of time:
an order amount of the online platform,
a number of active users of the online platform,
a gross merchandise volume (GMV) of the online platform, and
a gross profit of the online platform.

8. The method of claim 1, wherein
training the computer model further comprises:
pre-processing the historical records by adding an activeness feature, a reward label feature, and an event feature to the state information of each historical user, the activeness feature indicating whether the historical user is active, the reward label feature indicating a reward received by the historical user, and the event feature indicating whether the historical user was provided a historical incentive action.

9. (canceled)

10. A device, comprising a processor and a non-transitory computer-readable storage medium configured with instructions executable by the processor, wherein, upon being executed by the processor, the instructions cause the processor to perform operations comprising:
obtaining a computer model, wherein:
the computer model comprises an input unit, a processing unit, and an output unit,
the input unit is configured to:
obtain state information of a user of an online platform,
obtain an incentive action comprising a reward provided by the online platform to the user,
encode the state information of the user to generate encoded state information, and
encode the incentive action to generate an encoded action vector,
the processing unit is configured to:
determine, based on the encoded state information and the encoded action vector, a first simulation result of at least one performance criterion of the online platform with the incentive action being provided to the user, a second simulation result of the at least one performance criterion of the online platform with no incentive action being provided to the user, and a probability of activeness of the user using the online platform,
determine, based on the first simulation result and an order distribution function, a probability of reward representing a probability of the user receiving the reward in the incentive action, and
output the first and the second simulation results, the probability of activeness, and the probability of reward,
the output unit is configured to:
determine, based on the first and the second simulation results, the probability of activeness, and the probability of reward, an uplift on the at least one performance criterion of providing the incentive action to the user;
training, based on a plurality of historical records of the online platform, the computer model by:
generating, based on the historical records, test results for the at least one performance criterion corresponding to the plurality of historical records; and
adjusting, based on the test results and a loss function, a plurality of parameters of the computer model,
wherein the historical records include a plurality of counter-factual pairs each comprising a first historical record with a historical incentive action being provided and a second historical record with no incentive action being provided, the first historical record and the second historical record having similar state information, and
wherein the loss function includes a linear combination of a counter-factual loss function and a distribution discrepancy loss function, the counter-factual loss function including a summation of a difference between the test results of the first and the second historical records in the counter-factual pairs, the distribution discrepancy function reflecting a disproportion between the first historical records and the second historical records;
receiving a computing request related to one or more visiting users visiting the online platform, wherein the computing request comprises state information of the one or more visiting users;
determining, by feeding the state information of the one or more visiting users and one or more candidate incentive actions to the trained computer model, an uplift on the at least one performance criterion of providing each of the one or more candidate incentive actions to a target group, the target group comprising at least one of the one or more visiting users;
determining, based on the uplift on the at least one performance criterion, one of the one or more candidate incentive actions to be applied to the target group; and
transmitting a return signal to the target group, the return signal comprising the one of the one or more candidate incentive actions.

11. The device of claim 10, wherein determining one of the one or more candidate incentive actions to be applied to the target group comprises:
determining, based on the probability of reward and the order distribution function, a cost associated with each of the one or more candidate incentive actions; and
determining, based on the uplift on the at least one performance criterion and the cost associated with each of the one or more candidate incentive actions, the one of the one or more candidate incentive actions to be applied to the target group.

12. The device of claim 11, wherein the online platform is a ride-hailing platform, each of the one or more candidate incentive actions is a tiered coupon including a plurality of rewards each corresponding to one of a plurality of threshold order amounts, and
wherein determining the cost associated with each of the one or more candidate incentive actions comprises:
determining, based on the order distribution function, a tiered reward probability for each of the plurality of rewards in the tiered coupon; and
determining, based on the tiered reward probability for each of the plurality of rewards in the tiered coupon, the cost associated with each of the one or more candidate incentive actions.

13. The device of claim 10, wherein the state information of the user includes one or more time series features of the user and one or more static features of the user,
the one or more time series features include one or more of the following:
time information,
weather information,
location information, and
traffic condition information; and
the one or more static features include one or more of the following:
a name of the user,
a gender of the user, and
vehicle information.

14. The device of claim 10, wherein the processing unit includes a first component and a second component each comprising one or more neural networks,
the first component is configured to generate the first simulation result based on the encoded state information and the encoded action vector; and
the second component is configured to generate the second simulation result based on the encoded state information.

15. The device of claim 14, wherein the first component includes one or more first processing neural networks and one or more first prediction neural networks, the one or more first processing neural networks are configured to generate one or more first processed vectors corresponding to the first simulation result based on the encoded state information and the encoded action vector, and the one or more first prediction neural networks are configured to generate the first simulation result based on the one or more first processed vectors, and
the second component includes one or more second processing neural networks and one or more second prediction neural networks, the one or more second processing neural networks are configured to generate one or more second processed vectors corresponding to the second simulation result based on the encoded state information, and the one or more second prediction neural networks are configured to generate the second simulation result based on the one or more second processed vectors.

16. The device of claim 10, wherein the online platform is a ride-hailing platform, and the user is a driver of a vehicle or a passenger seeking transportation in a vehicle, and the at least one performance criterion comprises one or more of the following within a preset period of time:
an order amount of the online platform,
a number of active users of the online platform,
a gross merchandise volume (GMV) of the online platform, and
a gross profit of the online platform.

17. The device of claim 10, wherein
training the computer model further comprises:
pre-processing the historical records by adding an activeness feature, a reward label feature, and an event feature to the state information of each historical user, the activeness feature indicating whether the historical user is active, the reward label feature indicating a reward received by the historical user, and the event feature indicating whether the historical user was provided a historical incentive action.

18. (canceled)

19. A non-transitory computer-readable storage medium, configured with instructions executable by a processor, wherein upon being executed by the processor, the instructions cause the processor to perform operations, comprising:
obtaining a computer model, wherein:
the computer model comprises an input unit, a processing unit, and an output unit,
the input unit is configured to:
obtain state information of a user of an online platform,
obtain an incentive action comprising a reward provided by the online platform to the user,
encode the state information of the user to generate encoded state information, and
encode the incentive action to generate an encoded action vector,
the processing unit is configured to:
determine, based on the encoded state information and the encoded action vector, a first simulation result of at least one performance criterion of the online platform with the incentive action being provided to the user, a second simulation result of the at least one performance criterion of the online platform with no incentive action being provided to the user, and a probability of activeness of the user using the online platform,
determine, based on the first simulation result and an order distribution function, a probability of reward representing a probability of the user receiving the reward in the incentive action, and
output the first and the second simulation results, the probability of activeness, and the probability of reward,
the output unit is configured to:
determine, based on the first and the second simulation results, the probability of activeness, and the probability of reward, an uplift on the at least one performance criterion of providing the incentive action to the user;
training, based on a plurality of historical records of the online platform, the computer model by:
generating, based on the historical records, test results for the at least one performance criterion corresponding to the plurality of historical records; and
adjusting, based on the test results and a loss function, a plurality of parameters of the computer model,
wherein the historical records include a plurality of counter-factual pairs each comprising a first historical record with a historical incentive action being provided and a second historical record with no incentive action being provided, the first historical record and the second historical record having similar state information, and
wherein the loss function includes a linear combination of a counter-factual loss function and a distribution discrepancy loss function, the counter-factual loss function including a summation of a difference between the test results of the first and the second historical records in the counter-factual pairs, the distribution discrepancy function reflecting a disproportion between the first historical records and the second historical records;
receiving a computing request related to one or more visiting users visiting the online platform, wherein the computing request comprises state information of the one or more visiting users;
determining, by feeding the state information of the one or more visiting users and one or more candidate incentive actions to the trained computer model, an uplift on the at least one performance criterion of providing each of the one or more candidate incentive actions to a target group, the target group comprising at least one of the one or more visiting users;
determining, based on the uplift on the at least one performance criterion, one of the one or more candidate incentive actions to be applied to the target group; and
transmitting a return signal to the target group, the return signal comprising the one of the one or more candidate incentive actions.

20. The storage medium of claim 19, wherein determining one of the one or more candidate incentive actions to be applied to the target group comprises:
determining, based on the probability of reward and the order distribution function, a cost associated with each of the one or more candidate incentive actions; and
determining, based on the uplift on the at least one performance criterion and the cost associated with each of the one or more candidate incentive actions, the one of the one or more candidate incentive actions to be applied to the target group.
